(19) United States
(12) Patent Application Publication
(10) Pub. No.: US 2017/0330133 A1
(43) Pub. Date: Nov. 16, 2017

(54) ORGANIZING TRAINING SEQUENCES

(71) Applicant: Hewlett-Packard Development Company, L.P., Houston, TX (US)

(72) Inventors: Lei Liu, Palo Alto, CA (US); Steven J Simske, Ft. Collins, CO (US); Mary Brady, Sandton (ZA)

(21) Appl. No.: 15/522,732

(22) PCT Filed: Dec. 8, 2014
(86) PCT No.: PCT/US2014/069003

§ 371 Date: Apr. 27, 2017

(51) Int. Cl. G06Q 10/06; G06F 9/06; G06F 17/30; G06Q 50/20

(52) U.S. Cl. CPC G06Q 10/063116; G06Q 50/205; G06F 9/06; G06F 17/30035

(57) ABSTRACT

Examples disclosed herein involve organizing training sequences for tracing courses. Examples disclosed include analyzing a profile of a user comprising a list of skills learned by the user, analyzing a curriculum of a training course comprising lessons, and organizing a training sequence of the lessons based on the profile and the curriculum.

### BAGKGROUND

Training courses and lessons allow users to advance their skills in particular areas and subjects. Many training courses include a plurality of lessons on particular subject that can be learned to certify and/or license users that learn the lessons. Users may then be assessed on their knowledge of the learned lessons to provide proper certification or licenses. Online or digital training courses allow users to take training courses and/or access lessons over a network or via a computing device (e.g., a personal computer, a mobile device, tablet computer, etc.).

### BRIEF DESCRIPTION OF THE DRAWINGS

FIG. 1 illustrates a schematic diagram of an example training system including an example course generator that may be implemented in accordance with an aspect of this disclosure.

FIG. 2 a block digram of an example course generator that may be used to implement the course generator of FIG. 1.

FIG. 3 a block diagram of an example sequence organizer that may be implemented by the example course generator of FIG. 2.

FIG. 4 illustrates an example user profile database that may be implemented by the training system of FIG. 1.

FIG. 5 Illustrates an example course curriculum database that may be implemented by the training system of FIG. 1.

FIG. 6 is a flowchart representative of example machine readable instructions that may be executed to implement me course generator of FIG. 2.

FIG. 7 is a flowchart representative of an example portion of the example machine readable instructions of FIG. 6 to implement the course generator of FIG. 2.

FIG. 8 is a flowchart representative of another example portion of the example machine readable instructions of FIG. 6 to implement the course generator of FIG. 2.

FIG. 9 is another flowchart representative of example machine readable instructions that may be executed to implement the course generator of FIG. 2.

FIG. 10 is a flowchart representative of example machine readable instructions that may be executed to implement the training system of FIG. 1.

FIG. 11 is a block diagram of an example processor platform capable of executing the instructions of FIG. 6, 7, 8, 9, or 10 to implement the course generator of FIG. 2.

Wherever possible, the same or similar reference numbers will be used throughout the drawing(s) and accompanying written description to refer to the same or like parts.

### DETAILED DESCRIPTION

Examples disclosed herein involve analyzing a profile of a user and a curriculum of a training course to organize a sequence of lessons based on the profile and the curriculum. Accordingly, a personalized sequence of lessons may be generated for each user that wishes to take part in a particular training course. Therefore, a user's learning experience may be expedited or enhanced as the user's present level of skill for the course or learning preferences may be considered when organizing the sequence of lessons for the training course.

In many instances, training courses, lesson plans, and curriculum are established by instructors. Therefore, each user or student participating in the course follows a set lesson plan. Examples involved herein provide for personalized training courses eased on a profile of a user. The profile may be used to establish a skill level of a user based on previous work experience, education, etc. or learning preferences of the user. The training courses may be adapted to the user's profile based on whether the user already has a level of experience or skill in areas covered by the training courses. For example, skills that a user already possesses may be covered before skills that a user does not have to refresh the user's current skills and introduce the user to course subject matter before teaching the user new skills covered by the training course. On the other hand, the user may learn new skills first to introduce them to the new subject matter and allow for a simpler finish to the course with lessons covering skills that the user already possesses. Examples disclosed herein a allow for user preferences to be considered when generating a training course to personalize a training course for the user. For example, examples disclosed herein may consider whether the user prefers to learn new skills in the beginning or end of the course, which types of course materials or learning methods the user prefers, etc. Therefore, a training sequence of lessons of a training course for a first user may be different than a training sequence of the same lessons of the same training course for a second user.

An example method disclosed herein includes analyzing a profile of a user comprising a list of skills learned by the user in a user profile database, analyzing a curriculum of a training course comprising lessons in a course curriculum database, and organizing a training sequence of the lessons based on the profile and the curriculum. An example apparatus disclosed herein includes a profile manager to analyze a profile of a user, a curriculum manager to analyze lessons of a training course, and a sequence organizer to organize lessons of the training course into a sequence based on the profile of the user and the lessons.

As used herein a course (or training course) is defined as a training tool for teaching a user (e.g., a student trainee, etc.) a skill or skills in a particular area of expertise. The terms “course” and “training course” may be used herein interchangeably. As used herein, a lesson is defined as a set of training materials (e.g., documents, presentations, media (e.g., audio, video, etc.), tests, assignments, etc.) corresponding to a particular subject matter or expertise that may teach a user a particular skill or set of skills. In examples disclosed herein, a course may include a single lesson or multiple lessons. As used herein, cross-training courses are courses involving a same or similar skill or set of skills. As used herein, taking a training course involves accessing course materials of the training course or participating in exercises (e.g., assignments, tests, quizzes, etc.) of the training course for certification or completion of the course.

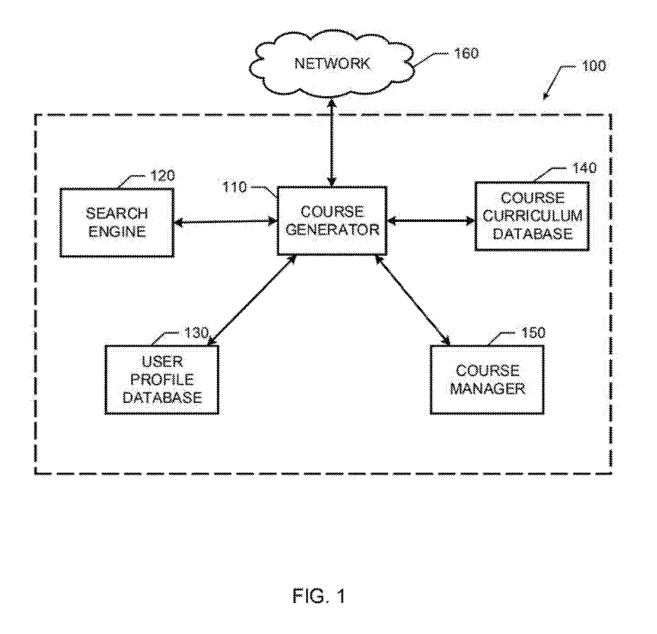

FIG. 1 illustrates a schematic diagram of an example training system 100 including an example course generator 110 that may be implemented in accordance with an aspect of this disclosure. The example training system 100 of FIG. 1 includes a search engine 120, a user profile database 130, a course curriculum database 140, and a course manager 150. The example training system 100 of FIG. 1 has access to a network 160. In FIG. 1, the course generator 110 communicates with or accesses, either directly or indirectly (e.g., via an intermediate component or a network, such as the network 160 or another network) the search engine 120, the user profile database 130, the course curriculum database 140, or the course manager 150 using any wired (e.g., serial, universal serial bus (USB), etc.) or wireless communication link (e.g., Wi-Fi, Bluetooth, etc.).

In the Illustrated example of FIG. 1, the search engine 120 may be any type of search engine (e.g., browser based, operating system (OS) based, application based, etc.). As further disclosed herein, the example search engine 120 may search for or identify users in the user profile database 130 or course materials in the course manager 150. For example, the search engine 120 may receive requests from the course generator 110 to identify a particular user and/or particular course materials to be learned by a user for a training course or compared to learned skills of a user in the course manager 150. In some examples, the search engine 120 may search the network 160 for course materials or information. For example, the search engine 120 may search for additional course materials for a particular lesson (e.g., based on subject matter or skills to be learned. In another example, the search engine 120 may be used to search for user information corresponding to a particular user (e.g., to verify user information, such as transcripts, work history, etc.).

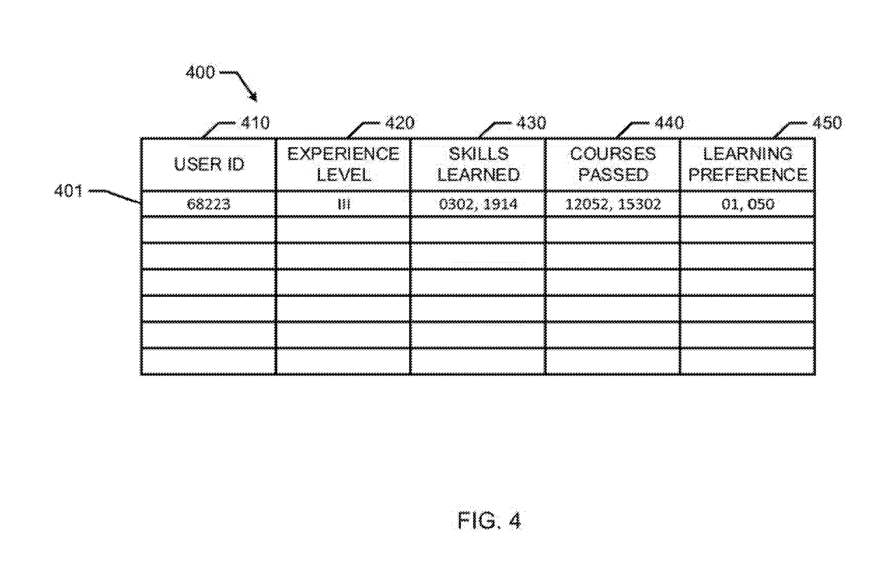

The example user profile database 130 of FIG. 1, as further described below in connection with FIG. 4, stores user information (e.g., in a user profile) corresponding to users associated with or managed by training system 100. User Information in the user profile database 130 may include corresponding user identifications/identifiers (IDs) (e.g., a name, a number, etc.), corresponding experience levels, corresponding learned skills, corresponding lessons passed, corresponding learning preferences, etc. Accordingly, an example profile for a user in the user profile database 130 may identify the user, a list skills learned by the user, learning preference(s) or priority(ies) of the user, etc. In some examples, the course generator 110 may manage or control the user profile database 130. For example, the course generator 110 may update, edit, remove, add, or delete user information from the user profile database 130.

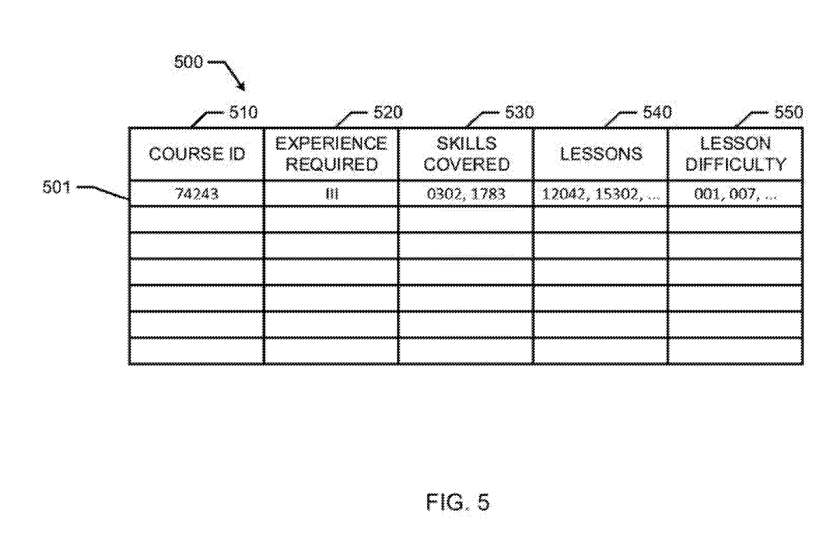

The example course curriculum database 140 of FIG. 1, as further described below in connection with FIG. 5, stores course information corresponding to courses associated with or managed by the training system 100. Course information in the course curriculum database 140 may include course IDs, corresponding degree level, corresponding skills, corresponding lessons, and corresponding lesson difficulties. In some examples, the course generator 110 may manage or control the course curriculum database 140. For example, the course generator 110 may update, edit, remove, add, or delete course information from the course curriculum database 140.

The example course manager 150 of FIG. 1 manages course matters including course assessment, course materials (e.g., documents, training media (e.g., audio files, videos, images, etc.), presentations, tests, assignments, etc.), lesson plans, lectures, problems, syllabi, etc. for courses or lessons of the training system 100. In some examples, the course manager 150 may be managed, updated, or controlled by the course generator 110. Accordingly, the course manager 150 may identify and or contribute skills to the course generator 110 and/or the course curriculum database 140 for particular courses.

In some examples, the course manager 150 of FIG. 1 may facilitate user assessment. For example, the course manager 150 may provide tests, quizzes, assignments (e.g., homework), etc. to users throughout a course and determine user progress throughout the course. For example, based on results from assessment materials (e.g., tests, quizzes, homework, etc,), the course manager 150 may determine whether the user has sufficiently or insufficiently learned the lessons or course materials or gained sufficient knowledge in those areas to advance to the next lesson or pass the course. Furthermore, the example course manager 150 may monitor a user's progress through a training course using assessments. In some examples, the course manager 150 may assess a user's knowledge (e.g., via tests, quizzes, etc.) of a particular skill after a corresponding lesson. In such examples, the course manager 150 may provide information to the course generator 110 to adjust or update a sequence of lessons for the course based on the assessment of the user's knowledge of the subject matter after each lesson of the training course. For example, a remaining sequence of lessons for a training course can be changed based on a user's assessed knowledge of the skills. In such an example, new lessons may be added to the remaining sequence, some lessons may be replaced by other lessons, or a lesson that was previously administered in the training course may be re-administered. Accordingly, the course manager 150 may instruct the course generator 110 to dynamically adjust a sequence of lessons for a training course as a user progresses through the training course.

In some examples, the course manager 150 of FIG. 1 may include or maintain a course materials database. In such examples, the course materials database may store course materials (e.g., documents, training media, presentations, tests, assignments, etc.). Furthermore, the example course generator 110 or search engine 120 may provide course materials (e.g., retrieved from the network 160) to be included in a course materials database managed by the course manager 150 for the training system 100 of FIG. 1.

The example network 180 may include any network, such as the Internet, a local area network (LAN), a wide area network (WAN), an intranet, a social network, etc. Accordingly, the course generator 110 or search engine 120 (or any other component of the training system 100) may access a plurality of machines, servers, computers, databases, etc. that may provide information associated with users, courses, skills, course materials etc. of the training system 100.

In examples disclosed herein, the course generator 110 of FIG. 1 generates a sequence of lessons based on information from the user profile database and the course curriculum database. In some examples, the course generator 110 generates a sequence of lessons for a course based on information or actions of the search engine 120 or the course manager 150. The example course generator 110 may compare information in the user profile database with information in the course curriculum database 140 to organize or reorganize lessons of a course. In examples, disclosed herein, the course generator 110 the sequences of lessons may be selected from or correspond to a learning graph. An example learning graph may be generated by the course generator 110 based on information from the user profile database 130 and the course curriculum database 140. In some examples, when a user selects to participate in a particular course, the course generator 110 may generate a cross-training graph based on skills common to a profile of the user in the user profile database 130 and the course in the course curriculum database 140.

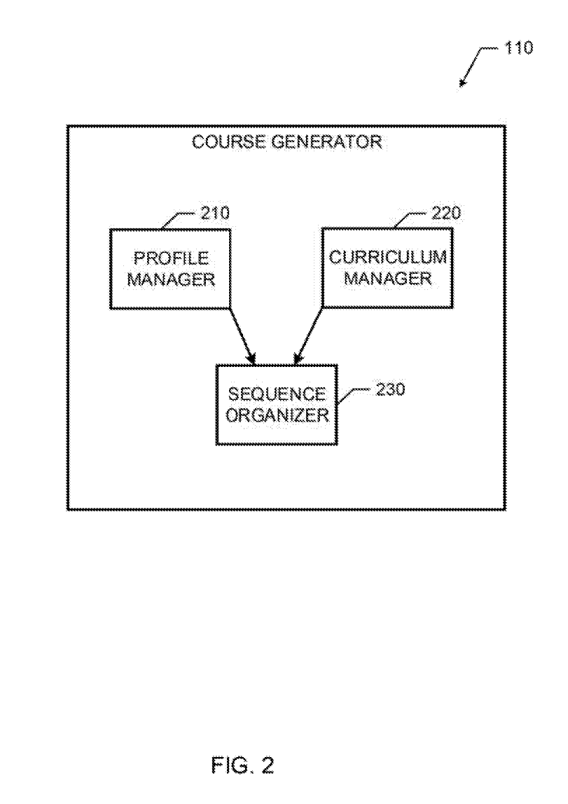

FIG. 2 is a block diagram of an example course generator 110 that may be used to implement the course generator 110 of FIG. 1. The example course generator 110 organizes a sequence of lessons for a course in accordance with the teachings of this disclosure. The course generator 110 of FIG. 2 includes a profile manager 210, a curriculum manager 220, and a sequence organizer 230. In the illustrated example of FIG. 2, the sequence organizer 230 communicates with the profile manager 210 and the curriculum manager 220. In some examples, the profile manager 210 and the curriculum manager 220 may communicate with one another.

The example profile manager 210 of FIG. 2 manages user profiles in a user profile database, such as the user profile database 130 of FIG. 1 (or FIG. 4). In examples disclosed herein, the profile manager 210 analyzes a profile (see FIG. 4) of a user. The profile manager 210 may identify particular skills or lessons learned by a particular user seeking to participate in a training course.

In some examples, the profile manager 210 may instruct the search engine 120 to identify or search for the user (e.g., via the network 160, a social network, the Internet, etc.). In such examples, the profile manager 210 may verify worn history, transcripts, skills, experience, etc. of the user or add work history, transcripts, skills, experience, etc. identified in the results of the search to the user profile database 130. For example, the profile manager 210 may analyze (e.g., via text recognition, text analysis, etc.) web pages (e.g., from a social media website, from an employer website, etc.) including user information that may be included in the user profile.

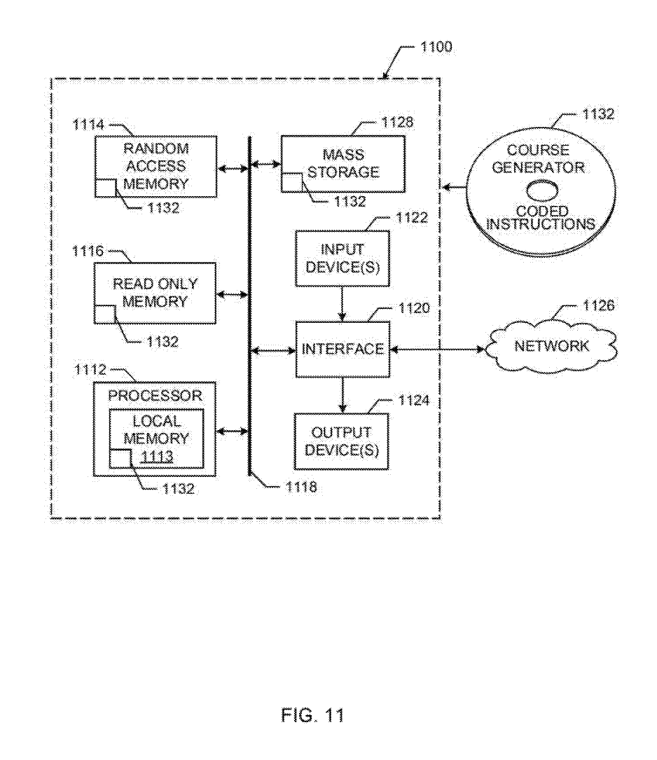

Furthermore, in some examples, the profile manager 210 may facilitate interaction with users. For example, the profile manager, via a user interface (e.g., the interface 1120 of FIG. 11), may request user profile information by providing questionnaires, surveys, forms, etc. to be filled out by the user when the user first accesses or registers an account with the training system 100 of FIG. 1. Example questionnaires, surveys, etc. may request a user to identify learning preferences (e g., using teaching media (audio, video, etc.), lectures, problem solving, theory-based teaching, application-based teaching, etc.) for determining a sequence for lessons of a training course. In some examples, the profile manager 210 may ask screening questions to ascertain a user's knowledge of a particular skill or topic. For example, the profile manager 210 may present questions having different levels of detail or difficulty to determine knowledge of a user in a particular skill or topic covered in the training course(s) that the user wishes to take. As a more specific example, if a user indicates that he or she has a particular skill on a questionnaire, follow up questions may be asked to determine a level of knowledge of the user in that particular skill. In such an example, the profile manager 210 may request the search engine 120 to retrieve (e.g., from the user profile database 130, from the network 160, etc.) questions corresponding to that particular skill level. In some examples, for each user, the profile manager 210 may build a profile from a set of documents (e.g., transcripts, resumes, questionnaires, forms, surveys, websites, social media profiles, etc.) to describe the user's knowledge. In some examples, the profile may be represented by a matrix defined by the number of documents and the level of knowledge of particular topics.

Accordingly, the profile manager 210 may retrieve, manage, and maintain user profile information for the course generator 110 to determine training sequences in accordance with the teachings of this disclosure.

The example curriculum manager 220 of FIG. 2 manages training course curriculums in the course curriculum database 140 of FIG. 1 (or FIG. 5). In some examples, the curriculum manager 220 analyzes lessons of a training course. The curriculum manager 220 may analyze the lessons of the training course to identify content or skills taught in the lessons. In some examples, the curriculum manager 220 may assign default settings for lessons of a course. For example, default settings (e.g., a sequence received from a course instructor) may be used in the curriculum database 140 to organize lessons of a course into a default sequence for presenting the lessons to a user. The example default sequence may be established by an instructor or administrator of the training system 100 of FIG. 1.

In some examples, the curriculum manager 220 of FIG. 2 may update or add lessons in the course curriculum database 140. For example, the curriculum manager 220 may instruct update the course curriculum database 140 to include lessons and/or skills training related to course materials, lessons, or other skills training identified by the search engine 120, the profile manager 210, etc. More specifically, a curriculum manager 220 may instruct the curriculum database 140 to add a lesson to a training course when the profile manager 210 determines that a user certified with a particular skill taught by that training course also participated in or learned the example lesson to be added. In another example, the curriculum manager 220 may instruct the search engine 120 to search for and retrieve lessons, course materials, etc. that may be used in a particular training course in the course curriculum database 140.

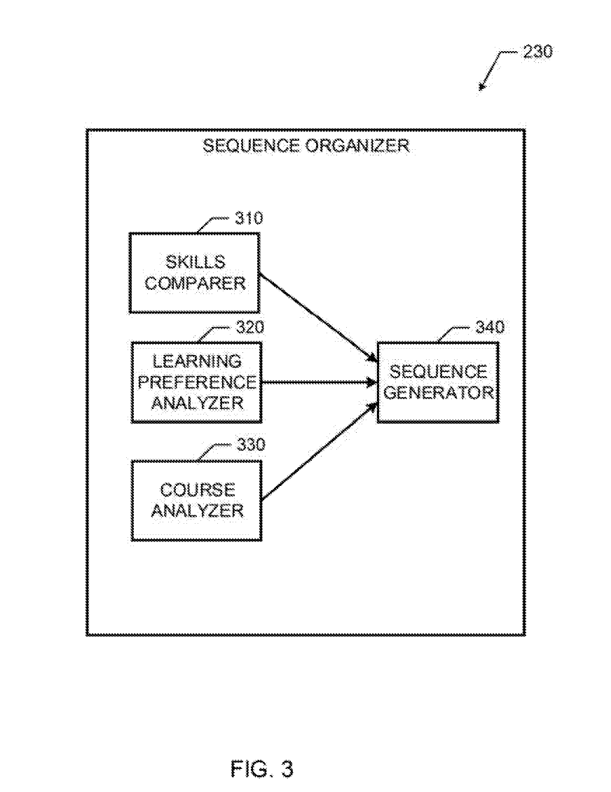

The example sequence organizer 230 of FIG. 2 organizes lessons of a training course into a sequence based on information received form the profile manager 210 and the curriculum manager 220. The example sequence organizer 230 uses user profile information, such as learned skills, work experience, learning preferences, etc., from the profile manager 210 to organize a training sequence of lessons of a course. As further described below in connection with FIG. 3, the example sequence organizer 230 uses course information (e.g., skills Involved, lesson difficulty, lesson plans, etc.) to organize the lessons of the example course in accordance with the teachings of this disclosures.

In some examples, the sequence organizer 230 generates a personalized training graph for a user. The example personalized training graph may include a plurality of sequences that may be generated for the user based on the skills or preferences of the user and the skills or difficulties to be learned in a training course. A user may select which sequence of the personalized training graph should be used for the training course. In some examples, the personalized training graph may be used for cross-training purposes. For example, the sequence organizer 230 may generate a training graph to reflect sequences (e.g., most similar skills/lessons to least similar skills/lessons, least similar skills/lessons to most similar skills/lessons, etc.) based on skills previously learned by a user and skills to be covered in a course. Accordingly, a training graph for a particular course may present different types of learning experiences and methods for respective users.

While an example manner of implementing the course generator 110 of FIG. 1 is illustrated in FIG. 2, at least one of the elements, processes and/or devices illustrated in FIG. 2 may be combined, divided, re-arranged, omitted, eliminated and/or implemented in any other way. Further, the profile manager 210, curriculum manager 220, sequence organizer 230 and/or, more generally, the example course generator 110 of FIG. 2 may be implemented by hardware and/or any combination of hardware and executable instructions (e.g., software and/or firmware). Thus, for example, any of the profile manager 210, curriculum manager 220, sequence organizer 230 and/or, more generally, the example course generator 110 could be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this patent to cover a purely software and/or firmware implementation, at least one of the profile manager 210, curriculum manager 220, or sequence organizer 230 is/are hereby expressly defined to include a tangible computer readable storage device or storage disk such as a memory, a digital versatile disk (DVD), a compact disk (CD), a Blu-ray disk, etc. storing the executable instructions. Further still, the example course generator 110 of FIG. 2 may include at least one element process, and/or device in addition to, or instead of, those illustrated in FIG. 2, and/or may include more than one of any or all of the illustrated elements, processes and devices.

FIG. 3 is a block diagram of a sequence organizer 230 that may be used to implement the sequence organizer 230 of FIG. 2. The example sequence organizer 310 includes a skills comparer 310, a learning preference manager 320, a course manager 330, and a sequence generator 340. In the example sequence organizer 230 of FIG. 3, the skills comparer 310, the learning preference organizer 320, and the course analyzer 330 provide information to the sequence generator 340 to organize lessons into a sequence (e.g., a personalized sequence) for a particular training course (e.g., a training course selected for participation by a user).

The example skills comparer 310 of FIG. 3 compares skills of a user (e.g., in the user profile database 130) and skills of a course (e.g., in the course curriculum database 140). Accordingly, the skills comparer 310 may measure a skills overlap between a profile and a course curriculum. The example skill comparer 310 may use a similarity function (e.g., a Jaccard score) to identify the same or similar skills in the profile of the user profile database 130 and a course curriculum in the course curriculum database 140 for ordering the sequence of lessons from most overlapping skills to least overlapping skills. For example, for each skill or topic found in a course curriculum, the skills comparer 310 may search through information or documents of a profile of a user to find any overlap or similarly learned skill or topic. In some examples, the skills comparer 310 may use a distance function (e.g., a Euclidean distance function) to order the sequence of lessons from least overlapping skills to most overlapping skills by, for each skill or topic, identifying farthest neighboring skills or topics in information or documents of the profile of the user. The skills comparer 310 of FIG. 3 may measure overlap indicator scores from functions (e.g., similarity functions, distance functions, etc.) used to compare the user profile and course curriculum. For example, the skills comparer 310 may determine an overlap score of p/k, where p represents a number of skills common to both a user profile and a course curriculum and k represents a number of skills identified in information or documents of the user profile.

The example learning preference analyzer 320 of FIG. 3 identifies learning preferences of a user. For example, the learning preference analyzer 320 may identify preferred learning methods (e.g., theory based teaching, application based teaching, experiments, demonstrations/examples, lectures, audio/visuals, participation, self-teaching exercises, etc.) of the user provided in questionnaires or surveys of the user or other users that have participated in similar courses. The learning preference analyzer 320 may provide the learning preferences to the sequence generator 340 for generating a sequence of lessons for a training course.

The example course analyzer 330 of FIG. 3 analyzes course information, documents, or content of a course (e.g., a course selected by a user for personalization). In some examples, the course analyzer 330 of FIG. 3 may analyze or identify content of course materials using Vector Space Machine (VSM), words-entity combination with natural language processing (NLP) analysis, n-grams to consider context of words within a n-size window, topics generated from a topic model, topic extraction methods (e.g., latent Dirichlet allocation (LDA), Singular value decomposition (SVD), etc.), or any other suitable content analysis. Additionally or alternatively, the example course analyzer 330 may identify new skills or topics in courses or in information or documents of a user profile. In some examples, the example course analyzer 330 may group skills and topics into a group corresponding to an expertise. For example, the course analyzer 330 may identify “driving,” “loading,” and “lifting” as skills of a forklift operator by analyzing fork lift operator profiles, fork lift operator training courses, etc.

The example course analyzer 330 of FIG. 3 may identify or determine groups of skills or topics using optimization tasks or algorithms. For example, solving the following optimization task may identify groups of skills or topics in a plurality of documents associated with a user having k topics/skills:

$$\begin{matrix}min {J}_{k} = {\sum }_{k = 1}^{K} {\sum }_{i ∈ {C}_{k}} {‖ {x}_{i} - {m}_{k} ‖}^{2} \\ = {\sum }_{i} {‖ {x}_{i} ‖}^{2} - {\sum }_{k} \frac{1}{{m}_{k}} {\sum }_{i , j ∈ {C}_{k}} {x}_{i} {x}_{j}^{T} \\ = Tr ( {X}^{T} X ) - Tr ( {HXX}^{T} {H}^{T} )\end{matrix}$$

where hₖ=(0, . . . , 0, 1, . . . , 1, 0, . . . , 0)^{T}/mₖ^{1/2}, as X^{T}X is a constant matrix, then minimizing Jₖ may be equivalent to maximizing the following trace:

$$\begin{matrix}{max}_{H} = Tr ( {HXX}^{T} {H}^{T} ) \\ = Tr ( {HKH}^{T} )\end{matrix} \qquad ( 1 )$$

In the example optimization task above,, where K is a liner kernel matrix, K=XX_{T}, similar to a K-means clustering. Accordingly, the course analyzer 330 may use example clustering or optimization tasks to identify groups of skills or topics in course documents, course materials, user profile information etc. in the user profile database 130 or the course curriculum database 140.

In some examples, the course analyzer 330 of FIG. 3 may use a kernel learning method to identify or determine which course information or user information corresponds to a same group (e.g., group of skills, group of topics, etc.) based on a Kernel function. Using the kernel function, the course analyzer 330 may identify skills or topics having a same generalness score from content analysis (e.g., using methods described above) of the user profiles or course curriculum in the user profile database 140 or course curriculum database 150, respectively. The example kernel functions may identify similar skills or topics and identify documents (e.g., resumes, transcripts, course materials, etc.) belonging to a group having a similar generalness score form the kernel function. For example, the course analyzer 330 may use the following kernel function:

$${W}_{ij} = sign \{ [ J ( {x}_{i} {x}_{j} ) - τ ] [ θ - ‖ E ( {x}_{i} ) - E ( {x}_{j} ) ‖ ] \} \\ where \text{:} \\ {W}_{ij} = \{ \begin{matrix}1 , & if J ( {x}_{i} {x}_{j} ) > τ and ‖ E ( {x}_{i} ) - E ( {x}_{j} ) ‖ < θ \\ - 1 , & otherwise\end{matrix} . \qquad ( 2 )$$

and the function J is a Jaccard score function that measures if a pair of documents (or other items of a course curriculum or user profile) include (or focus) on similar concepts or topics and the function E is an entropy function that measures a generalness score of the documents.

Additionally or alternatively, the course analyzer 330 may identify default settings of a sequence of courses. The example default settings may correspond to a sequence generated by an instructor or a sequence of lessons used in previously taught training course. In some examples, the course analyzer 330 may identify instructor sequencing criterion (e.g., indications of which lessons or course materials are to be arranged for particular courses). In some such examples, the instructor sequencing criterion is to be followed regardless of user preferences or user background knowledge. For example, such instructor sequencing criterion may indicate that particular lessons or course materials (e.g., documents and lectures) are to be covered during the course at a same or similar time or that one lesson or piece of course material is to be covered before or after another lesson or piece of course material, etc.

More specifically, the course analyzer 330 may account for instructor sequencing criterion utilizing the above Equation 1 and Equation 2. The course analyzer 330 may set Wᵢⱼ=1 in Equation 2 for course materials or documents (dᵢ and dⱼ) to be taught together (or at substantially the same time) and Wᵢⱼ=−1 in Equation 2 if the documents dᵢ and dⱼ are to be taught one after the other. The course analyzer 330 may set a kernel matrix K=W in Equation 1 to find groups of skills or topics in a course curriculum or course materials. The course analyzer 330 may implement a Jaccard score function, an entropy function, and the following objective function to consider document similarities:

$${L}_{G} = {\sum }_{ij} {{W}_{ij} ( {X}_{i} {GX}_{i}^{T} )}_{ij} + \frac{λ}{2} {G}_{ij}^{2} \qquad ( 3 )$$

where the first term in Equation 3 is minimized when matrices W and XₜGXₜ^{T} are in agreement with one another. The second term of Equation 3 (Gᵢⱼ²) may be a regularized term. The example course analyzer 330 may solve for G in Equation 3 by taking a partial derivative of the object function with respect to W and equating it to zero as follows:

$$\frac{\partial L}{{G}_{pq}} = - {\sum }_{ij} {W}_{ij} ( {X}_{ip} {X}_{qj}^{T} ) + λ {G}_{pq} = 0 \qquad ( 4 )$$

to get G=Xₜ^{T}WXₜ. Returning this kernel metric G=K back into Equation 1, the course analyzer 330 may solve for H and find corresponding groups or topics in consideration of the instructor sequencing criterion.

In some examples, the course analyzer 330 may identify difficulties associated with lesson(s) of the training course. For example, difficulty levels may be included in the course curriculum database 140 or information or documents associated with a training course. Accordingly, the course analyzer 330 may identifying rankings (e.g., representative of a difficulty) corresponding to the lessons in the curriculum and organize the training sequence of the lessons further based on the rankings. The example difficulties may be determined from content of the lessons (e.g., specific versus general), from questionnaires of users or instructors, test results, etc.

Accordingly, the course analyzer 330 of FIG. 3 may Identify or analyze information, documents, content, etc. of training courses. The course analyzer 330 may provide such information to the sequence generator 340 for organizing a sequence of lessons for a training course.

The example sequence generator 340 of FIG. 3 organizes a sequence or plurality of sequences of lessons or course materials for a course (e.g., a course selected by a user) based on information from the skills comparer 310, the learning preference analyzer 320, or the course analyzer 330 in accordance with the teachings of this disclosure. The example sequence generator 340 may use the information to build a training graph of sequences. Accordingly, after determining groups of skills or topics from the skills comparer 310, the learning preference analyzer 320, and the course analyzer 330, the sequence generator 340 may generate a personalized training sequence for taking a course. In some examples, the sequence may be determined using the following equation:

$$T ( {S}_{c} ) = \frac{1}{{n}_{c}} {\sum }_{i ∈ {S}_{c}} [ α E ( {x}_{i} ) + ( 1 - α ) {( p / k )}_{i} ] \qquad ( 5 )$$

where n_{c} is a number of documents in a cluster c, (p/k)ᵢ is a topic overlap score of the /th document (or course material) in a course curriculum (Xt), and α is a parameter controlling a tradeoff between an entropy score and the topic overlap. Accordingly, when α=1, the sequence generator 340 more heavily considers the entropy score and the sequence of lessons may be organized from general to specific content, while when α=0, the sequence generator 340 more heavily considers the topic overlap. Further, it is noted that when p/k=0 (i.e., there is no skill overlap or topic overlap, such as a hair designer taking a forklift operator course), using the above equation, the sequence generator 340 may organize content of a course from general topics to specific topics. In this example, once the sequence generator 340 determines the value of T for each group of topics (skills), the sequence generator 340 may link the groups based on a set of criteria. For example, the two groups (Sᵢ, Sⱼ) may be connected when a Jaccard score of the groups are greater than a threshold (which may be adjustable based on user preferences or instructor preferences). As another example, a sequence direction may be generated from one group (Sᵢ) to another (Sⱼ) (e.g., from one lesson on a topic or skill to another lesson on a topic or skill) to another when T(Sᵢ)>T(Sⱼ) (and vice versa).

The example sequence generator 340 of FIG. 3 may accordingly generate a sequence of lessons of a training course based on a profile of a user (e.g., using information from the skills comparer 310 or the learning analyzer 320) and on curriculum of a training course (e.g., based on information from a course analyzer 330).

While an example manner of implementing the sequence organizer 230 of FIG. 2 is illustrated in FIG. 3, at least one of the elements, processes and/or devices illustrated in FIG. 3 may be combined, divided, re-arranged, omitted, eliminated and/or implemented in any other way. Further, the skills comparer 310, the learning preference analyzer 320, the course analyzer 330, the sequence generator 340 or, more generally, the example sequence organizer 230 of FIG. 3 may be implemented by hardware and/or any combination of hardware and executable instructions (e.g., software and/or firmware). Thus, for example, any of the skills comparer 310, the learning preference analyzer 320, the course analyzer 330, the sequence generator 340 or, more generally, the example sequence organizer 230 could be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this patent to cover a purely software and/or firmware implementation, at least one of the skills comparer 310, the learning preference analyzer 320, the course analyzer 330, or the sequence generator 340 is/are hereby expressly defined to include a tangible computer readable storage device or storage disk such as a memory, a digital versatile disk (DVD), a compact disk (CD), a Blu-ray disk, etc. storing the executable instructions. Further still, the example sequence organizer 230 of FIG. 3 may include at least one element, process, and/or device in addition to, or instead of, those illustrated in FIG. 3, and/or may include more than one of any or all of the illustrated elements, processes and devices.

FIG. 4 is an example user profile database 400 that may be used to implement the user profile database 130 of FIG. 1. The example user profile database 400 of FIG. 4 includes columns for a user ID 410, an experience level 420, skills learned 430, courses passed 440, and learning preferences 450. In some examples, additional columns or information may be included or removed from the user profile database 400 of FIG. 4. The example fields 410-450 of the user profile database 400 may be populated by the course generator 110 (e,g., via the profile manager 210).

In the illustrated example of FIG. 4, the user profile database 400 includes an example profile 401 for a user identified by User ID 68223 in column 410. In some examples, a plurality of user profiles may be included in the user profile database 130. In the illustrated example, of FIG. 4, the user has an experience level of III, which may be representative of education received and/or work experience. Additionally, the user profile database 400 represents that the user has learned skills represented by skill numbers 0302 and 1914. These skills may have been extracted from user profile information or documents (e.g., from resumes, transcripts, questionnaires, surveys, forms, web pages, social media profiles, etc.) by the course generator 110 in accordance with the teachings of this disclosure. Furthermore, the example user profile database 400 of FIG. 4 represents that the user has passed courses represented by course numbers 12052 and 15302. The example course generator 110 may have derived this information from transcripts, course documents, or information from the course manager 150 (e.g., if the courses are associated with the training system 100 of FIG. 1). For example, the course manager 150 may update a user profile database (e.g., the user profile database 130, 400) after a user passes a training course of the training system 100. Additionally, as illustrated in the example of FIG. 4, the user profile database 400 may represent that the user has learning preferences represented by preference numbers 01 and 050. These example learning preferences may have been derived from questionnaires or forms filled out by the user upon registration for a course of the course curriculum database 140 or the training system 100.

Accordingly, the course generator 110 of FIG. 1 or 2 may retrieve information from the user profile database 400 or update the user profile database 400 of FIG. 4 to organize training sequences in accordance with the teachings of this disclosure.

FIG. 5 is an example course curriculum database 400 that may be used to implement the user profile database 130 of FIG. 1. The example course curriculum database 500 includes columns for a course ID 510, an experience required 520. skills covered 530, lessons 540, and lesson difficulty 550. In some examples, additional columns or information may be included or removed from the course curriculum database 500 of FIG. 5. The example fields 510-550 of the course curriculum database 500 may be populated by the course generator 110 (e.g., via the curriculum manager 220).

In the illustrated example of FIG. 5, the course curriculum database 500 includes example course information (e.g., a course curriculum) for a training course (referred in connection with FIG. 5 as “example course”) identified by Course ID 74243 in column 510. In some examples, the course curriculum database 500 may include more course information for a plurality of training courses. In the example of FIG. 5, the course information for the example course requires an experience level of “III.” Accordingly, the example experience level (in column 520) may indicate that a particular degree (e.g., a high school diploma, a general educational development (GED) certificate, an associate's degree, a bachelor's degree, a graduate degree, etc.) to participate in the example course. Further, the example course curriculum database 500 includes information corresponding to skills covered in the example course. In the illustrated example of FIG. 5 in column 530, the skills covered are represented by identification number 0302 and 1783. In some examples, the skills may be extracted from information or documents (e.g., lesson plans, syllabi, assignments, text books, etc.) for the example course. For example, the course generator (e.g., via the curriculum manager 220) may analyze a syllabus for the example course and identify the skills covered in the example course. Further, the example course curriculum database 500 includes lessons in column 540 (e.g., lessons corresponding to particular the identified skills). Again, the example course generator 110 derive the lessons from information or documentation associated with the example course. The course curriculum database 500 includes a lesson difficulty. The example lesson difficulty may correspond to the lessons indicated in column 540. Accordingly, the example course generator 110 may use the lesson difficulty to organize a sequence of lessons (e.g., to set a default sequence of lessons for a newly created course).

Accordingly, the course generator 110 of FIG. 1 or 2 may retrieve information from the course curriculum database 500 or update the course curriculum database 500 of FIG. 5 to organize training sequences in accordance with the teachings of this disclosure.

Flowcharts representative of example machine readable instructions for implementing the course generator 110 of FIG. 2 or 3 are shown in FIG. F. In this example, the machine readable instructions comprise a program(s)/process(es) for execution by a processor such as the processor 1112 shown in the example processor platform 1100 discussed below in connection with FIG. 11. The program(s)/process(es) may be embodied in executable instructions (e.g., software) stored on a tangible computer readable storage medium such as a CD-ROM, a floppy disk, a hard drive, a digital versatile disk (DVD), a Blu-ray disk, or a memory associated with the processor 1112, but the entire program/process and/or parts thereof could alternatively be executed by a device other than the processor 1112 and/or embodied in firmware or dedicated hardware. Further, although the example program(s) is/are described with reference to the flowcharts illustrated in FIG. F, many other methods of implementing the example course generator 110 may alternatively be used. For example, the order of execution of the blocks may be changed, and/or some of the blocks described may be changed, eliminated, or combined.

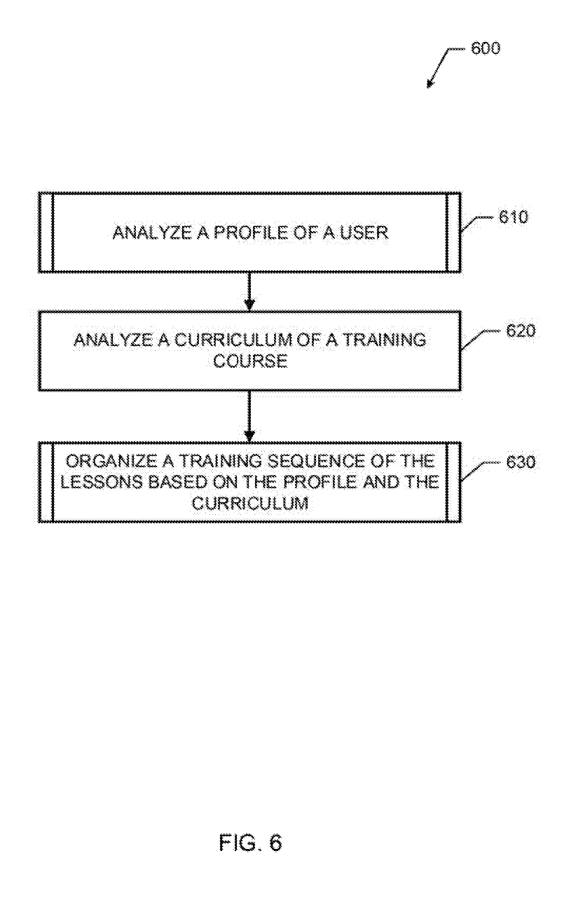

The process 600 of FIG. 6 begins with an initiation of the course generator 110 (e.g., upon startup, upon instructions from a user, upon startup of a device implementing the course generator 110 (e.g., a server, a computer, etc.), etc.). At block 610 of FIG. 6, the example profile manager 210 analyzes a profile of a user. In some examples, at block 610, the profile manager 210 analyzes the profile of the user to identify a list of skills of the user. For example, the profile manager 210 may analyze the user profile database 130 (or the user profile database 400) and/or information/documents stored in the user profile database 130 associated with the user to identify skills or experiences of the user. At block 620, the example curriculum manager 220 analyzes a curriculum of a training course. In some examples, the curriculum manager 220 may analyze course information in a course curriculum database (e.g., the course curriculum databases 140, 500) to identify skills covered in the training course. In some examples, the course curriculum manager 630 may analyze documents or files (e.g., lesson plans, syllabi, course materials, etc.) stored in the example course curriculum database. The example sequence organizer 230, at block 630, organizes a training sequence of lessons based on the profile and the curriculum. For example, as disclosed herein, the sequence organizer may compared skills of a user with skills covered in the course and organize a sequence of the lessons based on whether the skills of the user and the skills covered in the training course are similar or different. After block 630, the process 600 ends.

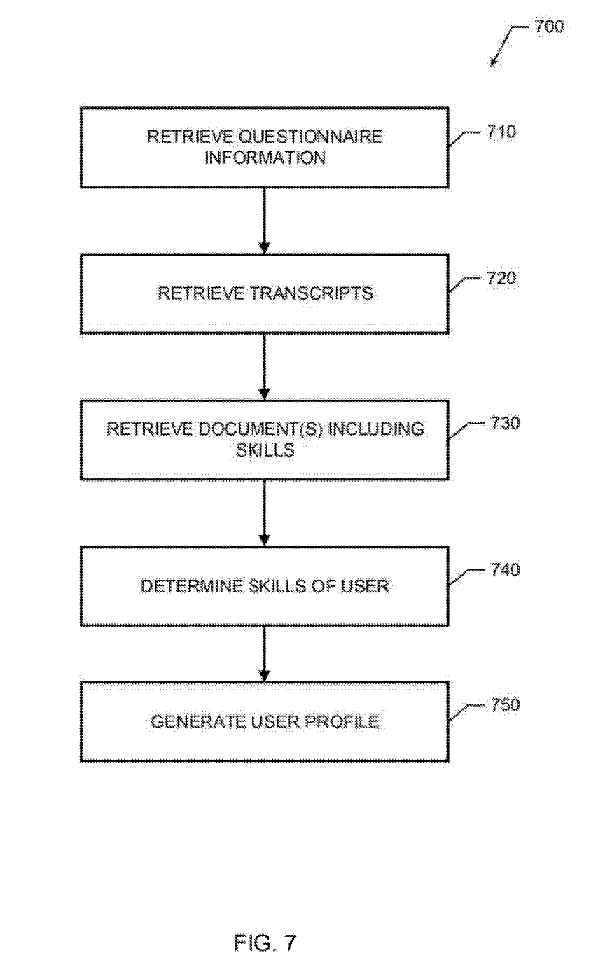

The process 700 of FIG. 7 begins with an initiation of the profile manager 210 (e.g., upon startup of the course generator 110, upon instructions from the course generator 110 or sequence organizer 230. etc.). The process 700 of FIG. 7 may be executed to generate or analyze a user profile for use in accordance with the teachings of this disclosure. In some examples, the process 700 may be executed to implement block 610 of FIG. 6. In FIG. 7, the blocks 710-750 may or may not be executed depending on whether information is available to the profile manager 210. At block 710, the example profile manager 710 retrieves questionnaire information. In some examples, the profile manager 210 may provide a questionnaire to a user (e.g., via a user interface) to retrieve the questionnaire information form the user. Such questionnaire information may include questions regarding skills of the user, learning preference of the user, work history of the user, etc. The example questionnaire information may be stored in the user profile database 130. At block 720, the profile manager 210 retrieves transcripts of the user. For example, the transcripts may be retrieved from a database (e.g., a university database, an online training course database, etc.). At block 730, the profile manager 210 may retrieve documents (e.g., resumes, social media web pages, etc.) that include skills of the user. For example, the profile manager 210 may request the search engine 120 to

At block 740, the profile manager 210 determines skills of the user (e.g., the questionnaire, the transcripts, the documents). In some examples, the profile manager 210 may identify each skill in the questionnaire, transcripts, and document(s) associated with a user. The example profile manager 210, at block 750, generates a user profile based on the information for analysis in accordance with the teachings of this disclosure. In some examples, the profile manger 210 may compare and account for duplicate skills identified in the documents (e.g., a same skill identified in a transcript and a resume) by including only one instance of the skill in the user profile database 130. After block 750, the process 700 ends.

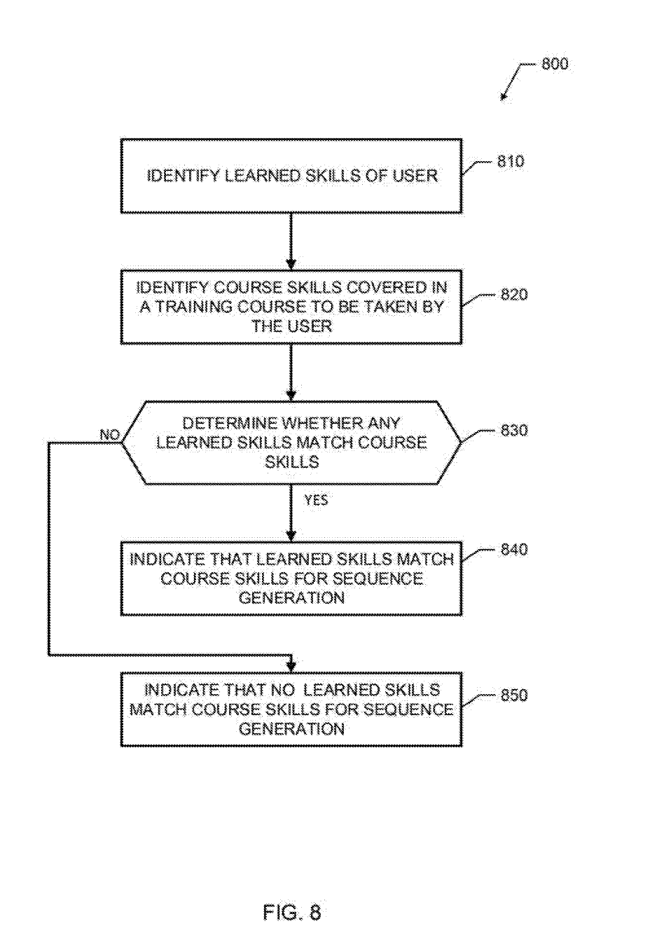

The process 800 of FIG. 8 begins with an initiation of the sequence organizer 230 (e.g., upon startup of the course generator 110, upon instructions from the course generator 110 or sequence organizer 230, etc.). The process 800 of FIG. 8 may be executed to generate or analyze a user profile for use in accordance with the teachings of this disclosure. In some examples, the process 800 may be executed to implement block 630 of FIG. 6. At block 810, the skills comparer 310 of the sequence organizer 230 identifies learned skills of a user. For example, the learned skills may be provided by the profile manager 210 or retrieved from the user profile database 130. At block 820, the skills comparer 310 identifies course skills covered in a training course (to be taken by the user). The sequence organizer 230, at block 820, may identify the course skills from the curriculum manager 220 or from course information in the course curriculum database 140.

At block 830, in the example process 800 of FIG. 8, the skills comparer 310 determines whether any learned skills match course skills. If, at block 830, none of the learned skills match the learned skills, control advances to block 850. If, at block 830, at least one learned skill matches a training skill, the skills comparer 310 indicates to the sequence generator 340 of the sequence organizer 230 that the skills match (840). In some examples, after block 840, the sequence generator 340 may organize lessons of the course from lessons including most learned skills to lessons including least learned skills (or vice versa) in accordance with the above. At block 850, the skills comparer 310 indicates to the sequence generator 340 that no learned skills match the course skills. In some examples, after block 850, the sequence generator 340 may then generate a sequence without considering whether a user has successfully learned skills covered in a training course. Accordingly, in such examples, default settings (e.g., instructor based settings, settings corresponding to a previously used sequence of lessons, etc.) may be used to generate a sequence of lessons for a training course.

After blocks 840 and 850, the process 800 ends. After execution of the process 800, the sequence generator 340 of the sequence organizer 230 may generate a sequence of lessons based on whether the skills learned match the course skills of the training course.

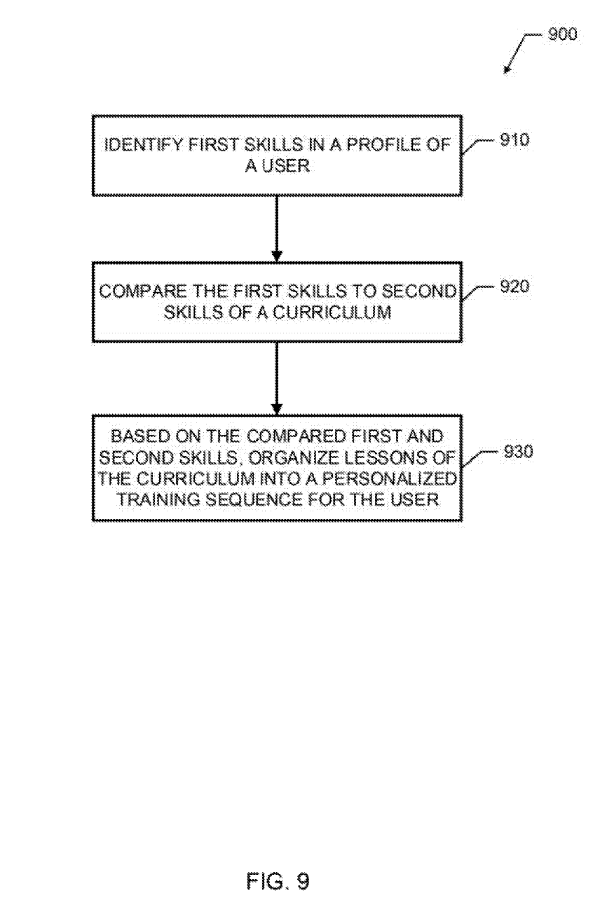

The process 900 of FIG. 9 begins with an initiation of the course generator 110. In some examples, the process 900 may be executed in addition to or as an alternative to the process 800 of FIG. 6 to implement the course generator 110. At block 910, the skills comparer 310 identifies first skills in a profile (e.g., from a profile (e.g., the profile 401 of FIG. 4) of the user profile database 130) of a user. At block 920, the skills comparer 310 compares the first skills to second skills of a curriculum (e.g., from course information (e.g., the course information 501) of the course curriculum database 140). The sequence generator 340, at block 930, organizes lessons of the curriculum into a personalized training sequence for the user based on the compared first and second skills. For example, the sequence generator 340 may consider the user's work experience, education, learning preferences, etc. to identify skills that may be covered in the curriculum of the course and organize the sequence if there are or are not skills common to both the user's profile and the course curriculum in accordance with the teachings of this disclosure. After block 930, the process 900 ends.

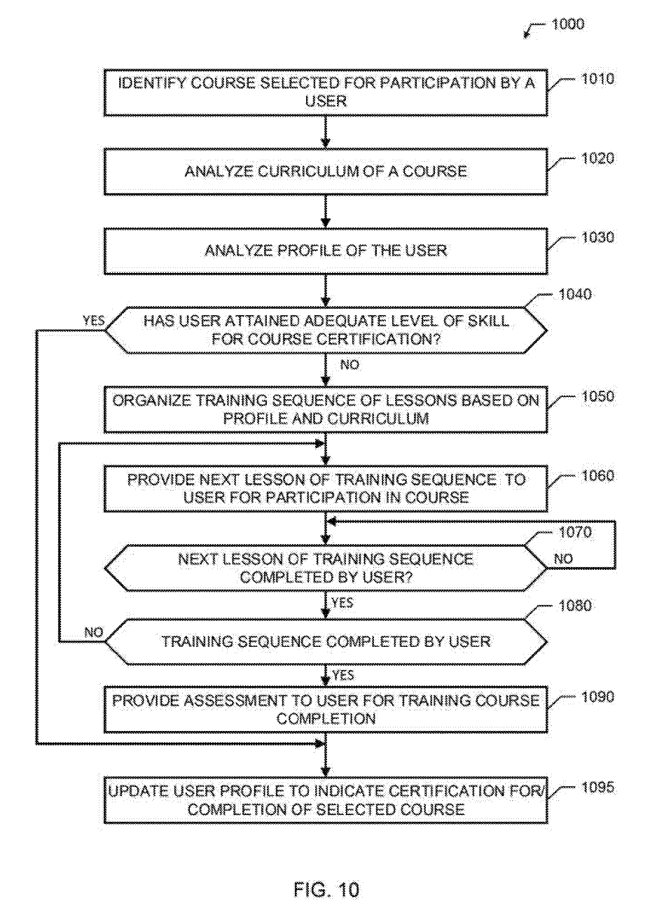

A flowchart representative of example machine readable instructions for implementing the training system 100 of FIG. 1 is shown in FIG. 10. In this example, the machine readable instructions comprise a program(s)/process(es) for execution by a processor such as the processor 1112 shown in the example processor platform 1100 discussed below in connection with FIG. 11. The program(s)/prooess(es) may be embodied in executable instructions (e.g., software) stored on a tangible computer readable storage medium such as a CD-ROM, a floppy disk, a hard drive, a digital versatile disk (DVD), a Blu-ray disk, or a memory associated with the processor 1112, but the entire program/process and/or parts thereof could alternatively be executed by a device other than the processor 1112 and/or embodied in firmware or dedicated hardware. Further, although the example program(s) is/are described with reference to the flowchart illustrated in FIG. 10, many other methods of implementing the example training system 100 may alternatively be used. For example, the order of execution of the blocks may be changed, and/or some of the blocks described may be changed, eliminated, or combined.

The example process 1000 of FIG. 10 begins with an initiation of the training system 100 (e.g., upon startup, upon instructions from a user or other system, etc.). The example process 1000 may be executed in addition to or alternative to the processes 600, 700, 800, 900 of FIGS. 6, 7, 8, 9, respectively. In the example process 1000 of FIG. 10, at block 1010, the course generator 110 identities a course selected for user participation. For example, at block 1010, the course generator 110 may receive a notification of a selected course or a request from a user via a user interface to participate in a course (e.g., a user interface implemented by the interface 1180 of FIG. 11). At block 1020, the course generator 110 (e.g., via the curriculum manager 220) analyses a curriculum of the identified course. At bock 230, the course generator 110 (e.g., via the profile manager 210) analyzes a user profile of the user that is to participate in the selected course.

In the example process 1000 of FIG. 10, at block 1040 the course manager 1040 determines whether the user has attained an adequate level of skill for course certification (e.g., in response to instructions from the course generator 110). If, at block 1040, the course manager determines that the user has attained adequate level of skill (e.g., due to already passing an assessment or test for the selected course, due to passing assessments of other courses teaching skills covered by the course, having significant experience in skills covered by the course, etc.), control advances to block 1090. If the course manager 150 determines that the user has not attained an adequate level of skill for course certification, the course generator 110, at block 1050, organizes a training sequence of lessons of the course based on the profile user and the curriculum of the course. In some examples, the process 600 (block 630) of FIG. 6 or the process 900 (or block 930) of FIG. 9, may be executed to implement block 1050 of FIG. 10. The course generator 110 or the course manager 150, at block 1060, provides a next lesson of the organized training sequence for the course to the user for participation in the course. For example, at block 1060, the course generator or course manager 150 may present course materials for the next lesson (e.g., lessons, lectures, media, images, problems, etc.) to the user via a user interface of the training system 100. At block 1060, the next lesson may be a first lesson of the training sequence if the user is beginning the course or any subsequent lesson if the user is continuing the course. In some examples, at block 1010, the example course materials for the lesson may be presented via an application, web browser, or any other suitable method.

At block 1070 in the example of FIG. 10, the course manager 150 determines (e.g., by monitoring the user's progress through the training sequence/course) whether the next lesson in the training sequence has been completed by the user (e.g., if the user has viewed, read, listened to, or adequately accessed the course materials, if the user has completed exercises of the lesson, etc.). If, at block 1070, the user has not completed the next lesson, control returns to block 1070 to monitor the user's progress. If the user completes next training course (block 1070), the course manager 150 determines whether the training sequence has been completed by the user at block 1080 (e.g., the next lesson is the final lesson of the training sequence). If the control manager 150, at block 1080, determines that the training sequence has not been completed by the user (e.g., the next lesson is not the last lesson of the training sequence, the next lesson was not properly completed, etc.), control returns to block 1060. If the control manager 150, at block 1080, determines that the user completed the training sequence, the control manager 150 provides an assessment to the user for training course completion 1090. For example, the course manager 150 may administer a test or examination centered on all skills and materials covered in the course. In some examples, the assessment provided to the user at block 1080 may be based on a sequence of the lessons of the training course (e.g., the sequence generated by the course generator 110). For example, the assessment may be provided in a same or different sequence to measure the user's knowledge of the subject matter. Accordingly, depending on settings of the training system 100 (e.g., based on instructor settings), the user may be assessed using a randomized sequence of assessments corresponding to the lessons or a same sequence of assessments corresponding to the lessons.

After block 1090, if the user does not adequately complete the assessment (e.g., pass the test), the course manager 150 may return control to block 1040. After block 1090, in the example of FIG. 10, the course generator (e.g., via the profile manager 210) or the course manager 150 may update the profile of the user (e.g., in the user profile database 130) to indicate certification for or completion of the selected course. Accordingly, the example process 1000 allows for dynamically updating user profiles for consideration of subsequent participation in courses selected by the user. After block 1095, the process 1000 ends.

As mentioned above, the example processes of FIG. 6, 7, 8, 9, or 10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 6, 7, 8, 9, or 10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, when the term “or” is used in a series, it is not, unless otherwise indicated, considered an “exclusive or.”

FIG. 11 is a block diagram of an example processor platform 1100 capable of executing the instructions of FIGS. 6, 7, 8, 9 to implement the course generator 110 of FIG. 2 or FIG. 10 to implement the training system 100 of FIG. 1. The example processor platform 1100 may be or may be included in any type of apparatus, such as a server, a personal computer, a mobile device (e.g., a cell phone, a smart phone, a tablet, etc.), a personal digital assistant (PDA), an Internet appliance, or any other type of computing device.

The processor platform 1100 of the illustrated example of FIG. 11 includes a processor 1112. The processor 1112 of the illustrated example is hardware. For example, the processor 1112 can be implemented by at least one integrated circuit, logic circuit, microprocessor or controller from any desired family or manufacturer.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a peripheral component interconnect (PCI) express interface.

In the illustrated example, at least one input device 1122 is connected to the interface circuit 1120. The input device(s) 1122 permit(s) a user to enter data and commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device 1124 is also connected to the interface circuit 1120 of the illustrated example. The output device(s) 1124 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1120 of the illustrated example, thus, may include a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes at least one mass storage device 1128 for storing executable instructions (e.g., software) and/or data. Examples of such mass storage device(s) 1128 include floppy disk drives, hard drive disks, compact disk drives, Blu-ray disk drives, RAID systems, secured disk (SD) drives, and digital versatile disk (DVD) drives.

The coded instructions 1132 of FIG. 6, 7, 8, 9, or 10 may be stored in the mass storage device 1128, in the local memory 1113 in the volatile memory 1114, in the non-volatile memory 1116, and/or on a removable tangible computer readable storage medium such as a CD or DVD.

From the foregoing, it will be appreciated that the above disclosed example methods, apparatus and articles of manufacture involve analyzing a user profile and a course curriculum to organize a sequence of lessons of a training course. Examples disclosed herein may consider a user's learning preferences for course participation. Accordingly, examples disclosed herein may provide for an enhanced or expedited learning experience for a user.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
analyzing a profile of a user in a user profile database, the profile comprising a list of skills learned by the user;
analyzing a curriculum of a training course in a course curriculum database, the curriculum comprising lessons; and
organizing, via a processor, a training sequence of the lessons based on the profile and the curriculum.

2. The method as defined in claim 1, further comprising:
identifying rankings corresponding to the lessons in the curriculum, each of the rankings representative of a difficulty of the corresponding lesson; and
organizing the training sequence of the lessons further based on the rankings;

3. The method as defined in claim 1, further comprising:
determining an experience level of the user for each skill in the list of skills; and
organizing the training sequence of the lessons further based on the experience levels of the user.

4. The method as defined in claim 1, wherein the profile further comprises a learning preference of the user, the method further comprising:
identifying the learning preference; and
organizing the training sequence of the lessons further based on the learning preference of the user.

5. The method as defined in claim 4, further comprising:
identifying methods of presenting the lessons of the curriculum; and
organizing the training sequence of the lessons with the identified lessons based on the learning preference of the user.

6. The method as defined in claim 1, further composing:
analyzing an assessment of the user based on completion of the training sequence of the lessons; and
updating the profile of the user based on the assessment.

7. The method as defined in claim 1, further comprising:
organizing the training sequence of the lessons from lessons most including the skills learned by the user to lessons least including the skills learned by the user.

8. The method as defined in claim 7, wherein organizing the training sequence comprises using a Jaccard score calculated between the profile and the curriculum.

9. The method as defined in claim 1, further comprising:
analyzing an assessment of the user after completion of each lesson of the sequence of lessons; and
dynamically adjusting the training sequence based on the assessments as the user progresses through the training course.

10. An apparatus comprising:
a profile manager to analyze a profile of a user, the profile comprising a list of skills previously learned by the user:
a curriculum manager to analyze lessons of a training course;
a sequence organizer to organize the lessons of the training course into a sequence based on the profile of the user and the lessons.

11. The apparatus as defined in claim 11, wherein the profile manager is further to:
facilitate retrieving learning preferences of the user and documents associated with the user to build the profile of the user.

12. The apparatus as defined in claim 10, wherein the curriculum manager is further to:
instruct a search engine to search for course materials for the training course; and
update a course curriculum of the training course with new course materials based on results retrieved by the search engine.

13. A non-transitory computer readable storage medium comprising instructions that, when executed, cause a machine to at least:
identify first skills in a profile of a user;
compare the first skills to second skills of a curriculum; and
based on the compared first and second skills, organize lessons of the curriculum into a personalized sequence for the user.

14. The non-transitory computer readable storage medium of claim 13, wherein the instructions further cause the machine to:
calculate a Jaccard score or a Euclidean distance between first content of the first skills and second content in the second skills; and
organize the lessons based on the Jaccard Score or the Euclidean distance.

15. The non-transitory computer readable storage medium of claim 13, wherein the instructions further cause the machine to:
identify third skills in a second profile of a second user;
compare the third skills to the second skills of the curriculum; and
based on the compared second and third skills, organize the lessons of the curriculum into a second personalized sequence for the second user, the second personalized sequence being different than the first personalized sequence.
